(19) United States
(12) Patent Application Publication
(10) Pub. No.: US 2010/0056652 A1
(43) Pub. Date: Mar. 4, 2010

(54) PROCESSES FOR FORMING HYDROPHILIC MEMBRANES AND POROUS MEMBRANES THEREOF

(75) Inventors: Hieu Minh Duong, Rosemead, CA (US); Ryan Austin Hutchinson, Albany, NY (US); David Roger Moore, Albany, NY (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/199,924

(22) Filed: Aug. 28, 2008

(51) Int. Cl. C08J 9/36; C08F 114/22; H05H 1/24

(52) U.S. Cl. 521/53; 521/143; 204/165

(57) ABSTRACT

A process of forming an integral hydrophilic membrane from a porous hydrophobic membrane includes exposing a porous hydrophobic polymer membrane to a plasma, wherein the plasma contains reactive carbon dioxide species configured to covalently bond carboxylic functional groups to a surface of the polymer membrane and form the integral hydrophilic membrane.

### BACKGROUND OF THE INVENTION

The present disclosure generally relates to a process of forming a permanently hydrophilic membrane, and more particularly a method for rendering porous fluoropolymer membranes hydrophilic.

Fluoropolymers such as polyvinylidene difluoride (PVDF), polytetrafluoroethylene (PTFE), and expanded PTFE (ePTFE) are mechanically and chemically robust, and high temperature materials. These advantageous properties are derived from the high strength of the carbon-fluorine bond, which mitigates chemical degradation. Membranes are often formed of porous fluoropolymers because of their chemical inertness and mechanical stability. Membranes can be useful in, for example, liquid size exclusion filtration applications. However, liquid water filtration is problematic due to the hydrophobic property of these types of fluoropolymers and may require treatment to impart hydrophilicity.

Hydrophilicity is defined as the property of being “water loving”. Hydrophilicity is typically used to describe a property of a material or molecule, and typically refers to the ability of the material or molecule to participate in hydrogen bonding with water. Furthermore, hydrophilic materials are typically attracted to, swell, or dissolve well within water. Hydrophilicity may be imparted to a PTFE, ePTFE, or PVDF membrane by, for example, by impregnation using a vinyl alcohol-based polymers or tetrafluoroethylene/vinyl alcohol copolymer. The tetra-fluoroethylene/vinyl alcohol copolymer approach leverages the chemical affinity of the perfluoropolymer in the coating material to the perfluoropolymer of the ePTFE. However, the affinity is sufficiently low that hydrophilicity may only be temporary. Other methods include coating the membrane interior of continuous pores with a mixture of a fluoroaliphatic surfactant and a hydrophilic but water insoluble polyurethane. Such an approach may leverage the chemical affinity between the perfluoropolymers to form a two-layer system. In another approach, for example, hydrophilicity of a PTFE membrane may be produced by irradiation treatment of the PTFE powdered resin. The resin may be processed with a porogen and virgin PTFE powder to render a microporous PTFE membrane. However, none of these processes provide permanent hydrophilic properties.

Other current methods are said to provide “permanent” hydrophilic properties. One method uses a polyvinyl nucleophilic polymer as a cross-linkable coating on the fluoropolymer membrane. Another method uses a hydrophilic coating comprising an electron beam reactive group bonded to the fluoropolymer membrane. While these methods could provide permanent hydrophilicity to the membrane, they both require the need to introduce a secondary hydrophilic polymer system to the process. Also, the second polymer can add an unnecessary additional layer to the membrane.

Moreover, many fluoropolymer membranes may be used for liquid water filtration, but require a pre-wet step generally with alcohols to enable water flow. This results in production considerations as these membranes must be prewetted by membrane manufacturers and shipped wet to end-users. Such a membrane may dewet or dry. The drying of the membrane may render it less effective and may necessitate, for example, undesirable shipping considerations (such as wet shipping). Other aspects may include economic considerations such as the need for special handling and sealable containers, and increased shipping weight, and the like.

### BRIEF DESCRIPTION OF THE INVENTION

Disclosed herein are methods of forming hydrophilic membranes, and the porous membranes thereof. In one embodiment, a process of forming an integral hydrophilic membrane from a porous hydrophobic membrane includes exposing a porous hydrophobic polymer membrane to a plasma, wherein the plasma contains reactive carbon dioxide species configured to covalently bond functional groups to a surface of the polymer membrane and form the integral hydrophilic membrane.

In another embodiment, the process further comprises immersing the integral hydrophilic membrane in a chemical solution that increases hydrophilicity of the membrane.

In yet another embodiment, the process further comprises immersing the integral hydrophilic membrane in the chemical solution; removing the hydrophilic membrane from the chemical solution; and autoclaving the removed membrane.

An integral hydrophilic membrane includes a porous fluorinated polymer membrane comprising a surface, and a functional group covalently bonded pendant to the fluorinated polymer surface, wherein the functional group is configured to provide hydrophilicity to the surface, and wherein the functional group consists of carboxylic acid, carboxylate, latent carboxylic acid, or a combination comprising at least one of the foregoing.

The above described and other features are exemplified by the following figures and detailed description.

### BRIEF DESCRIPTION OF THE DRAWINGS

Referring now to the figures, which are exemplary embodiments, and wherein the like elements are numbered alike:

FIG. 1 are scanning electron micrographs illustrating PVDF membranes before and after CO₂ plasma treatment of various treatment times;

FIG. 2 schematically illustrates an exemplary embodiment of a roll-to-roll CO₂ plasma treatment system;

FIG. 3 shows a chart of the results of an x-ray photoelectron spectroscopy analysis comparing an untreated PVDF membrane with a PVDF membrane CO₂ plasma treated for 20 minutes;

FIG. 4 graphically illustrates the ¹H NMR analysis results comparing an untreated PVDF membrane with a PVDF membrane CO₂ plasma treated for 20 minutes;

FIG. 5 graphically illustrates the IR spectroscopy results comparing an untreated PVDF membrane with a PVDF membrane CO₂ plasma treated for 20 minutes;

FIG. 6 graphically illustrates water flow rate as a function of CO₂ plasma treatment time on PVDF membranes;

FIG. 7 graphically illustrates extractables weight loss as a function of CO₂ plasma treatment time for PVDF membranes;

FIG. 8 graphically illustrates water flow rate as a function of CO₂ plasma treatment time, after the treated PVDF membranes were immersed in a EGDE or a DEA chemical solution; and

FIG. 9 graphically illustrates extractables weight loss as a function of CO₂ plasma treatment time, after the treated PVDF membranes were immersed in the EGDE or DEA chemical solutions.

### DETAILED DESCRIPTION OF THE INVENTION

Disclosed herein are inherently hydrophobic, porous polymer membranes rendered permanently hydrophilic by using plasmas comprising reactive carbon dioxide species to generate an integral hydrophilic membrane surface throughout the membrane, including the surfaces of the internal pores. The resulting integral hydrophilic membrane can exhibit high water flow, low extractables, and autoclavability. In particular, the membranes can have excellent water wettability, consistent flow rates, and almost no extractables over multiple wet-dry cycles and/or repeated steam sterilization cycles (autoclave) with virtually no weight loss or degradation of the membrane. The process disclosed herein advantageously can be accomplished in one step. The process does not require a second hydrophilic polymer system to be coated, bonded, or the like to the porous polymer membrane, nor does it require another compound to impart the hydrophilic functional groups to the membrane.

Various materials can be used for forming the membrane. Suitable fluorinated polymers can include, without limitation, ePTFE, PTFE, PVDF, polyvinylidene diflouride, poly(tetrafluoroethylene-co-hexafluoropropylene (FEP), poly(ethylene-alt-tetrafluoroethylene) (ETFE), polychlorotrifluoroethylene (PCTFE), poly(tetrafluoroethylene-co-perfluoropropyl vinyl ether) (PFA), poly(vinylidene fluoride-co-hexafluoropropylene (PVDF-co-HFP), and polyvinyl fluoride (PVF). Other materials and methods that can be used to form the membrane include polyolefins (e.g., polyethylene, polypropylene, polymethylpentene, polystyrene, substituted polystyrenes, poly(vinyl chloride) (PVC), polyacrylonitriles), polyamide, polyester, polysulfone, polyether, acrylic and methacrylic polymers, polystyrene, polyurethane, polycarbonates, polyesters (e.g., polyethylene terephthalic ester, polybutylene terephthalic ester), polyether sulfones, polypropylene, polyethylene, polyphenylene sulfone, cellulosic polymer, polyphenylene oxide, polyamides (e.g., nylon, polyphenylene terephthalamide) and combinations comprising two or more of the foregoing polymers.

Suitable methods of making the membrane include foaming, skiving, or casting any of the suitable materials. The membrane may be rendered porous by, for example, one or more of perforating, stretching, expanding, bubbling, or extracting the base membrane. In alternative embodiments, the membrane may be formed from woven or non-woven fibers.

The membranes can be closed pore or the pores can be continuous. In one embodiment, the surfaces of the membrane define many interconnected pores that fluidly communicate with environments adjacent to the opposite facing major sides of the membrane. The propensity of the material of the membrane to permit a liquid material, for example, an aqueous polar liquid, to wet out and pass through pores may be expressed as a function of one or more properties. The properties may include the surface energy of the membrane, the surface tension of the liquid material, the relative contact angle between the material of the membrane and the liquid material, the size or effective flow area of pores, and the compatibility of the material of the membrane and the liquid material. Thus, in a specific embodiment, continuous pores are present, thereby providing permeability to the membranes.

In either type of membrane, suitable porosity may be in a range of greater than about 10 percent by volume. In one embodiment, the porosity may be in a range of from about 10 percent to about 20 percent, from about 20 percent to about 30 percent, from about 30 percent to about 40 percent, from about 40 percent to about 50 percent, from about 50 percent to about 60 percent, from about 60 percent to about 70 percent, from about 70 percent to about 80 percent, from about 80 percent to about 90 percent, or greater than about 90 percent by volume. Here and throughout the specification and claims, range limitations may be combined and/or interchanged. Such ranges are identified by their range limitations, and include all the sub-ranges contained therein unless context or language indicates otherwise.

Pore diameter may be uniform from pore to pore, and the pores may define a predetermined pattern. Alternatively, the pore diameter may differ from pore to pore, and the pores may define an irregular pattern. Suitable pore diameters may be less than about 50 micrometers. In one embodiment, an average pore diameter may be in a range of from about 50 micrometers to about 40 micrometers, from about 40 micrometers to about 30 micrometers, from about 30 micrometers to about 20 micrometers, from about 20 micrometers to about 10 micrometers, from about 10 micrometers to about 1 micrometer. In one embodiment, the average pore diameter may be less than about 1 micrometer, in a range of from about 1 micrometer to about 0.5 micrometers, from about 0.5 micrometers to about 0.25 micrometers, from about 0.25 micrometers to about 0.1 micrometers, or less than about 0.1 micrometers. In one embodiment, the average pore diameter may be in a range of from about 0.1 micrometers to about 0.01 micrometers.

In one embodiment, the membrane may have a lattice-type structure including a plurality of nodes interconnected by a plurality of fibrils, wherein the surfaces of the nodes and fibrils define a plurality of pores in the membrane. The size of a fibril that has been at least partially sintered may be in a range of from about 0.05 micrometers to about 0.5 micrometers in diameter taken in a direction normal to the longitudinal extent of the fibril. The specific surface area of the porous membrane may be in a range of from about 0.5 square meters per gram of membrane material to about 110 square meters per gram of membrane material.

To provide a permeable membrane, these surfaces of the nodes and fibrils define interconnecting pores that extend through the membrane between opposite major side surfaces in a tortuous path. In this embodiment, the average effective pore size of pores in the membrane may be in the micrometer range. A suitable average effective pore size for pores in the membrane may be in a range of from about 0.01 micrometers to about 0.1 micrometers, from about 0.1 micrometers to about 5 microns, from about 5 micrometers to about 10 micrometers, or greater than about 10 micrometers.

Membranes having a node and fibril structure may be made by extruding a mixture of fine powder particles and lubricant. The extrudate subsequently is calendared. The calendared extrudate is then “expanded” or stretched in one or more directions, to form fibrils connecting nodes to define the lattice-type structure. “Expanded” means stretched beyond the elastic limit of the material to introduce permanent set or elongation to fibrils. The membrane may be heated or “sintered” to reduce and minimize residual stress in the membrane material by changing portions of the material from a crystalline state to an amorphous state. In one embodiment, the membrane may be unsintered or partially sintered as is appropriate for the contemplated end use of the membrane.

The membrane can either be supported on or bonded to (i.e., attached, adhered, cohered, held together, fastened, affixed, laminated, sealed, secured, and the like) a support during plasma exposure. The support can be any suitable material that does not degrade, e.g., deform or tear, during the subsequent preparation and testing stages. Examples of suitable supports can include sheets of synthetic resins such as, without limitation, polyvinyl chloride, polyvinylidene chloride, fluoropolymers including polychlorotrifluoroethylene (PCTFE), polystyrene, polymethacrylates, polyacrylamides, polyethylene, polypropylene, polyamides, polycarbonates, cellulose esters, and polyesters.

The membrane can be bonded to the support by methods known to those skilled in the art, for example, by mechanical, chemical, solvent, and/or thermal bonding. For example, the membrane can be bonded to the support by the application of heat, pressure, glue, adhesive, chemical, and/or solvent. Typically, the membrane is removably or temporarily bonded to the support. For example, the bonding is carried out such that the resulting porous membrane can be separated or removed from the support without significantly affecting the membrane, e.g., by deforming, distorting, chemically or physically altering, or tearing. If needed, the membrane and/or the support can be treated to achieve the optimal bonding strength, for example, to increase the bonding strength. The membrane and support can then be CO₂ plasma treated.

Without being bound by theory, it is believed that the hydrophobic polymer membrane is rendered hydrophilic by covalent attachment of the carbon and oxygen atoms of the CO₂ molecule to the membrane surface upon exposing the surfaces of the membrane to the CO₂-containing plasma. This process can include generating reactive, ionized carbon dioxide species from a plasma gas mixture and exposing the porous hydrophobic polymer membrane to the reactive species. The reactive carbon dioxide species in the plasma are effective to covalently bond carboxylic functional groups to a surface of the polymer membrane and form the integral hydrophilic membrane. The particular carbon dioxide components of the plasma gas mixture are selected by their ability to form a gas and plasma at appropriate conditions. The gas mixture selected is free from components that generate other reactive species that can bond non-carboxylic functional groups to the polymer backbone of the membrane. Again, the reactive carbon dioxide species formed when the plasma is generated from the gas mixture primarily reacts with carbon and other atoms in the hydrophobic polymer to form hydrophilic functional groups and impart integral hydrophilic properties to the membrane. In one embodiment, the porous hydrophobic polymer membrane is exposed to the reactive carbon dioxide species in the plasma for a duration of about 10 seconds to about 120 minutes.

In a particularly advantageous feature of this process, the high permeability of the membrane to the plasma results in substantially all of the membrane surfaces being rendered hydrophilic, including the surfaces of the internal pores, even when pore size is very small, or the path defined by the pores is highly tortuous. In another advantageous feature, this process produces a hydrophilic surface with very low, or approaching zero extractables (i.e., no unwanted materials eluting off of the membrane). As used herein “low extractables” means a membrane in which less than about 2 percent by weight of the membrane elutes during autoclave cycles.

In a specific embodiment, less than 10 percent by weight, specifically less than 5 percent by weight, even more specifically less than 1 percent by weight of the membrane is lost after soaking in stirring water at 80 degrees Celsius (° C.) for 24 hours. Moreover, the covalent linkage of the CO₂ hydrophilic functionality inherently offers higher durability and robustness over current hydrophilic polymer coating membranes. These current membranes can be known to shift or elute from the filtration media in water filtration applications.

The theoretical reaction for making a permanently hydrophilic porous PVDF membrane is shown below. The hydrophobic PVDF membrane is likely functionalized by the CO₂ plasma treatment according to the following equation:

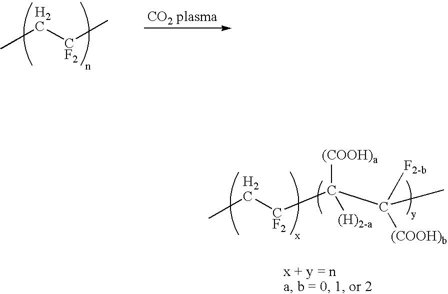

There are a number of possible substructures bearing one to four carboxylic acid functionality per repeat unit that could result from exposure to CO₂ plasma. Insertion of CO₂ into a C—H bond or abstraction of hydrogen followed by attack of the reactive CO₂ plasma and reaction with a radical hydrogen would give an aliphatic carboxylic acid. The fluorinated carboxylic acid could be made by fluorine abstraction, and attack of the CO₂ plasma and reaction with a hydrogen radical. As will be seen, proton NMR data shows two distinct COOH peaks, which is indicative of at least 2 magnetically inequivalent COOH hydrogens, most likely only one or two carboxylic acid groups per repeat unit. In general, the CO₂ plasma is effective to covalently bond carboxylic acid groups to the backbone of the polymer membrane, thereby imparting hydrophilic properties to the surface of the membrane and the internal pore surfaces comprised in the membrane.

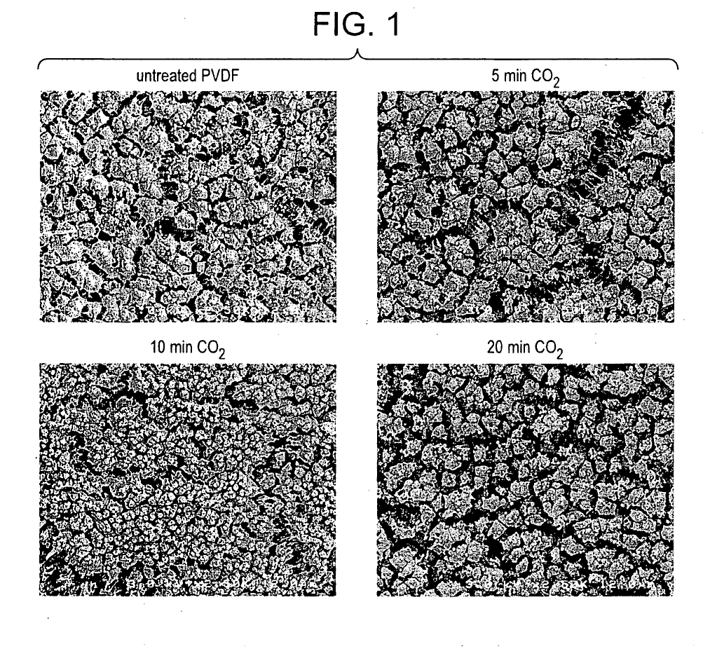

The plasma treatment occurs under conditions suitable to render the hydrophobic polymer membrane hydrophilic. Process conditions for the treatment can depend on a number of factors, such as, without limitation, the type of membrane to be treated, CO₂ content of the plasma, plasma system equipment, plasma treatment conditions including voltage applied across the electrodes and system pressure, desired treatment duration, and the like. In an exemplary embodiment, the CO₂-containing plasma can comprise about 1 percent to about 100 percent by weight of carbon dioxide. In a further exemplary embodiment, the plasma treatment pressure can be about 50 millimeters of mercury (mtorr) to about 1000 mtorr (about 13 Pascals (Pa) to about 133 Pa), specifically about 100 mtorr to about 700 mtorr (about 27 Pa to about 93 Pa), more specifically about 250 mtorr to about 500 mtorr (about 33 Pa to about 67 Pa). The plasma-generating electrodes can be operated at a power effective to generate the plasma and cause the CO₂ molecule to covalently bond to the polymeric membrane. In an exemplary embodiment the plasma electrode power can be about 500 watts to about 10,000 watts, specifically about 3000 watts to about 7000 watts. Similarly, the flow rate of the CO₂-containing plasma can be any rate suitable to render the polymer membrane permanently hydrophilic. Exemplary plasma flow rates can be about 0.1 standard liters per minute (slm) to about 100 slm, specifically about 0.5 slm to about 50 slm, more specifically about 2 slm to about 4 slm, and even more specifically about 2.5 slm. Also, the treatment time (i.e., dwell time) for the membrane exposure to the plasma can vary and will depend on the above described process conditions, as well as the plasma composition, membrane composition, and the like. Examples of plasma treatment durations can be less than 1 minute to greater than 30 minutes. In an exemplary embodiment, the treatment time can be about 1 minute to about 30 minutes, specifically about 2 minutes to about 20 minutes, more specifically about 5 to about 10 minutes. Temperatures during the plasma treatment can be about 25° C. FIG. 1 illustrates scanning electron micrographs (SEMs) before CO₂ plasma treatment, after 5 minutes treatment, 10 minutes treatment, and 20 minutes treatment of a PVDF porous membrane prepared in accordance with the above process. The CO₂ plasma treatment was performed at a pressure of 400 mtorr, with a plasma flow rate of 2.5 slm.

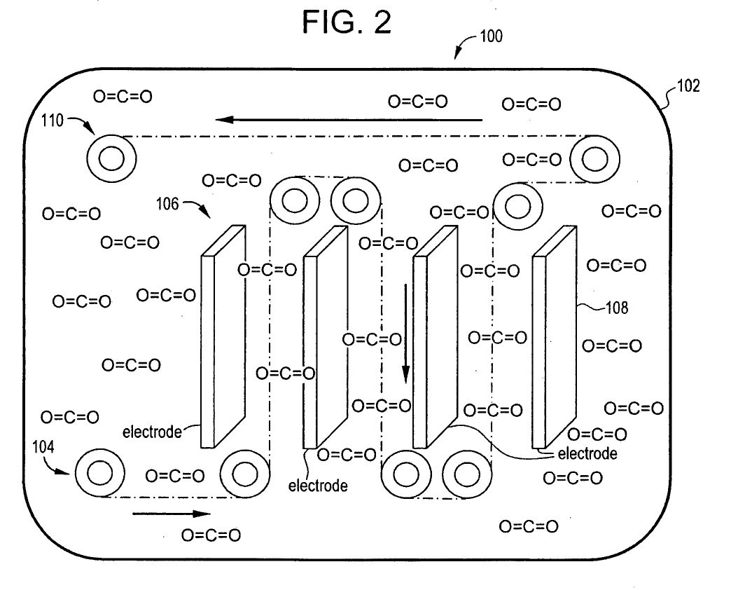

The plasma system for rendering the hydrophobic polymer membrane hydrophilic can comprise a roll-to-roll system. FIG. 2 illustrates an exemplary embodiment of a roll-to-roll plasma system 100. The entire system 100 can be disposed in a housing 102, which can be evacuated to the desired pressure during the CO₂ plasma treatment. A roll 104 of a hydrophobic polymer membrane sheet can be disposed on one end of a plasma electrode array 106. The hydrophobic polymer membrane can pass back and forth between each pair of electrodes 108 in the array, as the CO₂ plasma is generated and the carbonyl groups are covalently attached to the membrane. After passing through the electrode array 106, the now hydrophilic polymer membrane sheet can be wound on a finished product roll 110. Exemplary roll-to-roll plasma systems are commercially available from, among others, Marchi Plasma Systems.

In an optional embodiment, the polymer membrane can be further treated with a chemical solution to further improve the hydrophilicity (i.e., wetting) of the membrane after the CO₂ plasma treatment. Any hydrophilic reagent that can react or make an ionic salt with the carboxylic acid could be utilized. Examples of reagents can include alcohols, thiols, alkenes, and epoxides that covalently react with carboxylic acids. Also, amines will form ionic salts with the carboxylic acids, and under some conditions can react to form amides. Furthermore, the carboxylic acids could be derivatized into carbonyl halides, anhydrides, or other more reactive moieties and derivatized. A sheet or the like of the treated membrane can be immersed in a chemical solution for a time effective to saturate the porous membrane. Exemplary saturation time can be from about 1 minute to about 24 hours. Exemplary chemical solutions for wetting enhancement of the post-plasma treated membrane can include, without limitation, diethanolamine, ethylene glycol diglycidyl ether, ethylene glycol diglycidyl ether with hydrochloric acid, combinations thereof, and the like. Other exemplary chemical solutions can include ethylene oxide, propylene oxide, glycidyl trimethylammonium chloride, or glycidol in a basic solution, such as triethylamine, 4-dimethylaminopyridine, sodium hydroxide, or the like base, and combinations thereof. In such a case, the membrane can be immersed in a solution combining both the reactive species (e.g., ethylene oxide) and the base solution (e.g., 4-dimethylaminopyridine), or the membrane can be immersed into each separately. For example, the membrane could be first dipped into the basic solution to deprotonate carboxylic acid to carboxylate, and then dip into the second solution of the reactive species.

In still another optional embodiment, the water flow rates through the plasma treated membrane can be improved in filtration applications when the membrane is further subjected to autoclaving. Manufacturers generally utilize heat sterilization cycles to destroy microbes in their products; therefore, permanent autoclavability is a useful consideration for these membranes. A widely-used method for heat sterilization is the autoclave. Autoclaves commonly uses steam heated to about 121° C. at 15 pounds per square inch (psi) above atmospheric pressure. Advantageously, not only does the autoclave have no detrimental effect on the CO₂ plasma treatment of the hydrophilic polymer membrane, but, as stated above, the water flow rate through the membrane can be increased. The membrane can be repeatably autoclavable without loss of hydrophilicity as measured in terms of extractable weight loss, which is an indication of its permanence and robustness, and repeated water wettability. The extractable weight loss measurements will be shown and described in more detail in the Examples section below. Also, the present disclosure is not intended to be limited to any particular autoclave process or apparatus.

Membranes as described herein can have differing dimensions, some selected with reference to application-specific criteria. In one embodiment, the membrane may have a thickness in the direction of fluid flow in a range of less than about 10 micrometers. In another embodiment, the membrane can have a thickness in the direction of fluid flow in a range of greater than about 10 micrometers, for example, in ranges of from about 10 micrometers to about 100 micrometers, about 100 micrometers to about 1 millimeter, about 1 millimeter to about 5 millimeters, or in a range beginning at greater than about 5 millimeters. Perpendicular to the direction of fluid flow, the membrane can have a width of greater than about 10 millimeters. In one embodiment, the membrane can have a width in ranges of from about 10 millimeters to about 45 millimeters, about 45 millimeters to about 50 millimeters, from about 50 millimeters to about 10 centimeters, from about 10 centimeters to about 100 centimeters, from about 100 centimeters to about 500 centimeters, from about 500 centimeters to about 1 meter, or in a range beginning at greater than about 1 meter. The width may be a diameter of a circular area, or may be the distance to the nearest peripheral edge of a polygonal area. In one embodiment, the membrane may be rectangular, having a width in the meter range and an indeterminate length. That is, the membrane may be formed into a roll with the length determined by cutting the membrane at predetermined distances during a continuous formation operation after plasma treatment in a roll-to-roll plasma system.

A membrane prepared by the methods described herein can have one or more predetermined properties. Exemplary properties can include, without limitation, one or more of a wettability of a dry-shipped membrane, a wet/dry cycling ability, filtering of polar liquid or solution, flow of non-aqueous liquid or solution, flow and/or permanence under low pH conditions, flow and/or permanence under high pH conditions, flow and/or permanence at room temperature conditions, flow and/or permanence at elevated temperature conditions, flow and/or permanence at elevated pressures, transparency to energy of predetermined wavelengths, transparency to acoustic energy, or support for catalytic material. Permanence further refers to the ability of the membrane to maintain function in a continuing manner, for example, for more than 1 day or more than one cycle (wet/dry, hot/cold, high/low pH, and the like).

The flow rate of fluid through the membrane can be dependent on one or more factors. Exemplary factors can include, without limitation, one or more of the physical and/or chemical properties of the membrane, the properties of the fluid (e.g., viscosity, pH, solute, and the like), environmental properties (e.g., temperature, pressure, and the like), and the like. In one embodiment, the membrane can be permeable to vapor rather than, or in addition to, fluid or liquid. A suitable vapor transmission rate, where present, may be in a range of less than about 1000 grams per square meter per day (g/m²/day), from about 1000 g/m²/day to about 1500 g/m²/day, from about 1500 g/m²/day to about 2000 g/m²/day, or greater than about 2000 g/m²/day. In one embodiment, the membrane can be selectively impermeable to liquid or fluid, while remaining permeable to vapor.

The following examples are presented for illustrative purposes only, and are not intended to limiting in scope.

### EXAMPLES

In the following examples, a PVDF polymer disposed on a non-woven, melt blown polypropylene support was used to examine the properties and benefits of a membrane produced and treated as described above. The PVDF polymer used had a nominal pore size rating of 1.2 micrometers and is commercially available from GE Water and Process Technologies. The membrane thickness for the examples was about 76 micrometers (3 mils). Ethylene glycol diglycidyl ether (EGDE) and diethanolamine (DEA) were used as the chemical solution for post-plasma treatment in some of the examples. The reagents are commercially available from Sigma-Aldrich Company. Nuclear magnetic resonance (NMR) spectra were recorded on a Bruker Avance 400 (¹H, 400 MHz) spectrometer and referenced versus residual solvent shifts. Weight percents were calculated to determine the amount of membrane remaining after autoclave and were determined by relating the membrane weight before autoclave to the membrane weight after autoclave. X-ray photoelectron spectroscopy (XPS) was conducted for the treated membranes. The surfaces were analyzed as received by collecting both low resolution survey scans to determine the overall elemental surface compositions and high resolution spectra for the elements present to identify the species present. The samples were analyzed on a Kratos Ultra XPS using a 325-watt A1 Kα. monochromatic X-ray source. The analytical area was 700×350 μm slot. The approximate depth of analysis was about 50-75 Å. Fourier transform infrared spectroscopy (FT-IR) analysis was also performed on the membranes. FT-IR analysis was performed on a Nicolet Protégé 460, made by Nicolet Instrument Corp. A background spectrum was obtained and 16 interferograms were collected on the sample prior to the Fourier transform and spectra were baseline corrected.

Flow rates of water were performed at 20 inches Hg pressure differential and reported in milliliters per minute-centimeters squared (mL/min-cm²). The CO₂ plasma treatment experiments were performed with equipment from March Plasma Systems. In each experiment, a 2 square foot sample of the PVDF membrane was mounted on a sample-rack and placed between two electrodes in the plasma system. The system was operated at 40 kilohertz (kHz) at a temperature of 25° C. The CO₂ plasma flow rate through the plasma system was 2.5 slm, and the system was operated under a pressure of 400 mtorr. The electrodes were tuned to a power of 1000 watts. Membranes were treated in the plasma system for a various amount of treatment times. The membranes were weighed before and after the plasma treatment using a microbalance. Extractables testing was done according to the following procedure. The membranes were dried at 70° C. for 1 hour to remove residual volatiles and weighed using a microbalance. Membranes were confined in a mesh screen and soaked in stirring water at 80° C. for 24 hours. The membranes were then dried at 70° C. for 1 hour and weighed using a microbalance. Percent extractables were determined by the weight percentage difference between the dried samples before and after extraction. For some samples, autoclaving was done using a Steris Sterilizer, Amsco Century SV-148H Prevac Steam Sterilizer at 121° C. and 21 psi for 30 minutes.

### Example 1

### Spectroscopy Analysis

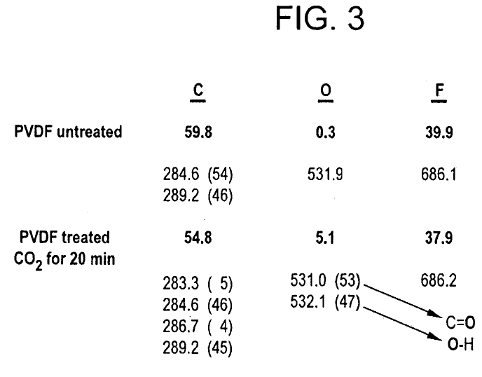

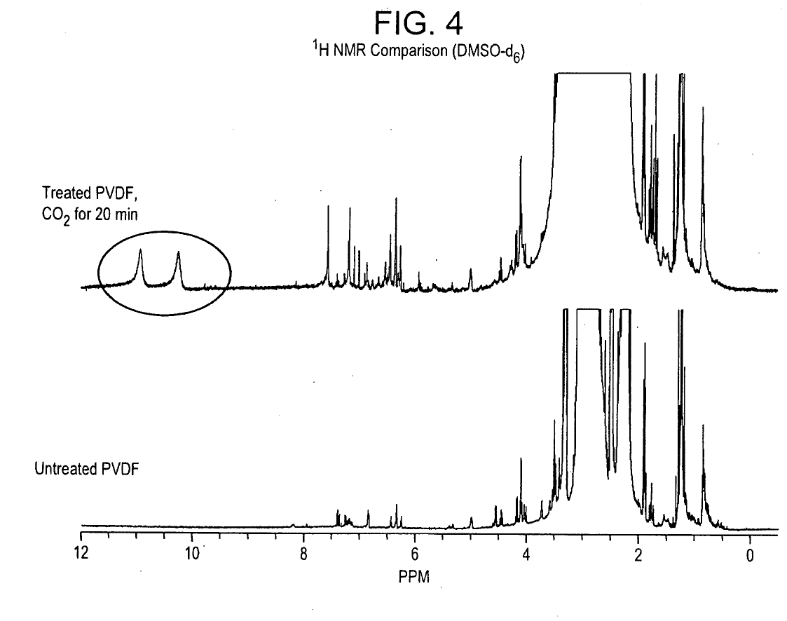

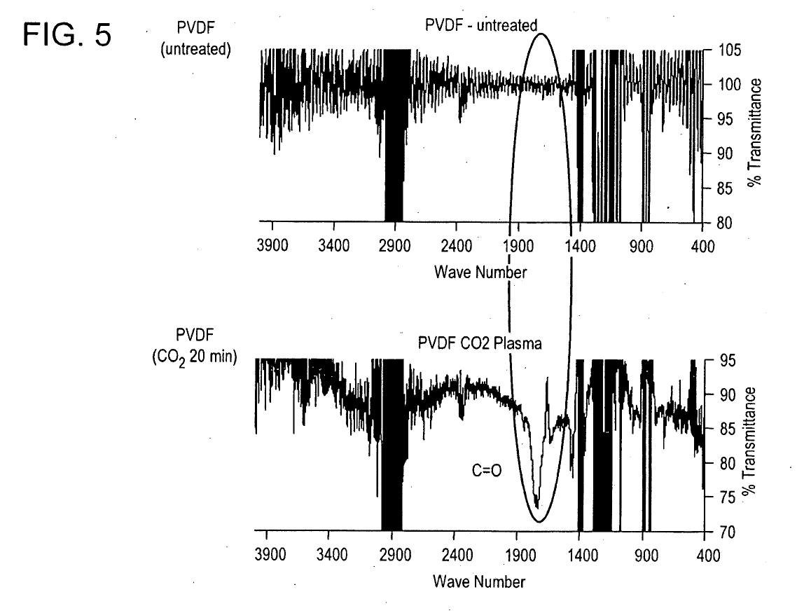

In this example, the PVDF membrane was treated with CO₂ plasma in the system and under the conditions described above. The PVDF membrane was plasma treated for 20 minutes, and x-ray photoelectron spectroscopy (XPS), NMR, and infrared spectroscopy (IR) analysis was done to evaluate the effect of the plasma treatment on the microstructure of the PVDF membrane. FIG. 3 shows the XPS analysis of an untreated PVDF membrane compared with the CO₂ plasma treated PVDF membrane of Example 1. As highlighted in FIG. 3, the XPS results showed the presence of covalent attachment of the carbon and oxygen molecules of the CO₂ plasma to the PVDF. FIG. 4 illustrates the ¹H NMR analysis. Again, the figure is a side-by-side comparison of an untreated PVDF membrane with the Example 1 membrane. ¹H NMR showed chemical shifts in the vicinity of carboxylic acid functionality formed by the CO₂ plasma treatment. Similarly, as seen in the illustration of FIG. 5, the IR analysis shows the presence of the carbonyl functional group, which is not seen in the IR spectrum of the untreated PVDF membrane. As seen, therefore, by the various analysis methods, the CO₂ plasma treatment is effective to bond partial carboxylations to the PVDF membrane, thereby imparting permanent hydrophilic properties to the membrane.

### Example 2

### Water Flow Performance and Autoclave

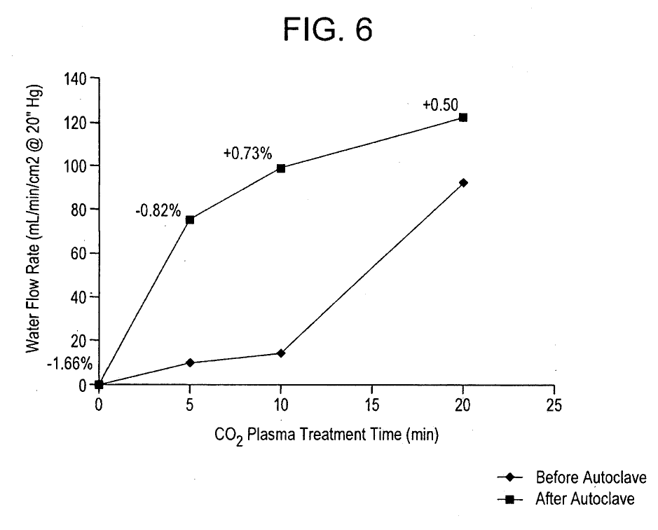

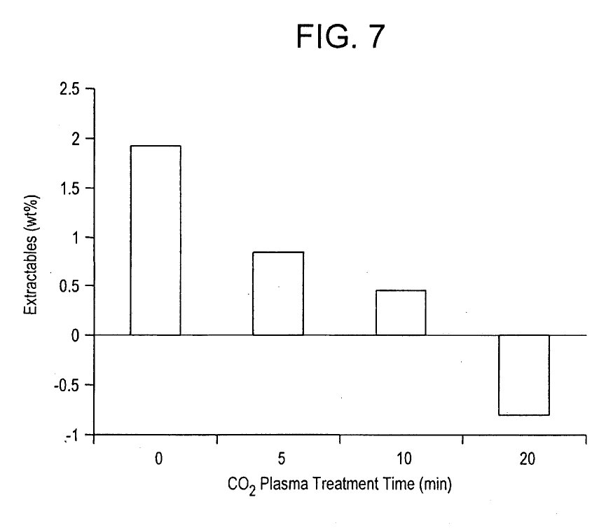

In this example, three different PVDF membranes were treated with CO₂ plasma in the system and under the conditions described above. Three of the PVDF membranes were plasma treated for a duration of 5, 10, or 20 minutes. A fourth PVDF membrane sample was left untreated for comparison. The water flow performance as a function of the CO₂ plasma treatment time was measured and is shown in FIG. 6. The chart shows the treated and untreated membrane samples both before and after autoclave. The autoclave was conducted under the conditions described above. As can be seen from the figure, as the plasma treatment time is increased, the water flow rate through the treated membrane increases. The untreated sample had no water flow through the membrane, indicating the non-wetting hydrophobic nature of the PVDF polymer. After autoclaving, the water flow rates of the plasma treated membranes were further increased. The percent weight changes of the PVDF membranes after autoclave are also shown on the chart. Very little weight change occurs from the autoclave. This indicates that the CO₂ plasma treatment produces a hydrophilic surface that does not permit material to elute off the membrane surface. FIG. 7 further illustrates the low extractable nature of the hydrophilic surface created by the CO₂ plasma treatment. FIG. 7 is a bar graph showing the percent weight of extractables of the plasma treated membranes before autoclave measured as a function of plasma treatment time. Lower extractables are seen from the membranes as CO₂ plasma treatment time increases.

### Example 3

### Chemical Solution Post-Plasma Treatment

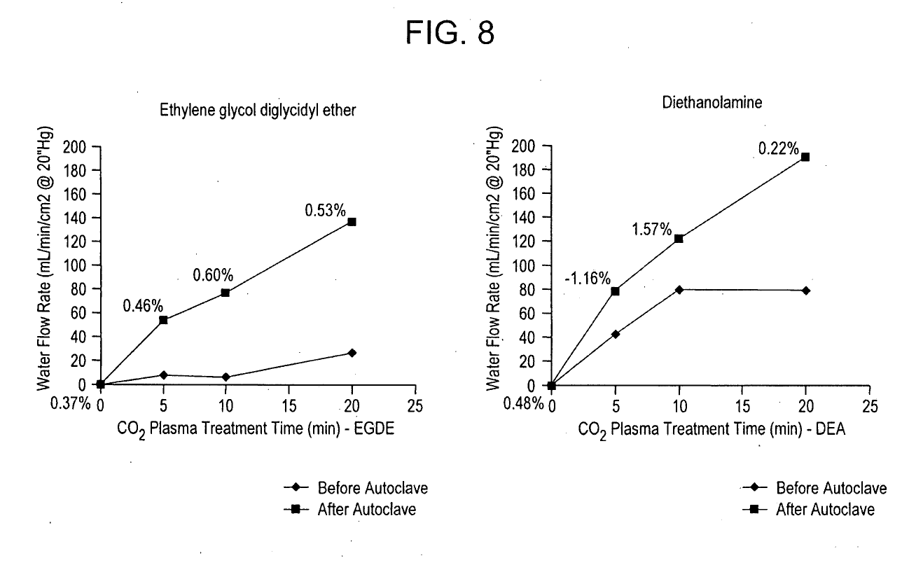

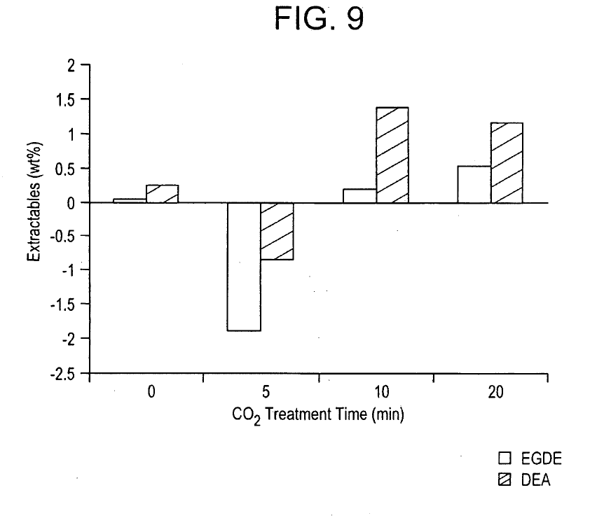

In this example, two sets of four different PVDF membranes were treated with CO₂ plasma in the system and under the conditions described above in Example 2. Again, in each sample set, three of the PVDF membranes were plasma treated for a duration of 5, 10, or 20 minutes, and a fourth PVDF membrane was left untreated for comparison. Before autoclaving, however, each of the samples was immersed in a chemical solution for a duration of 15 hours. The first set of PVDF membrane samples were immersed in a EGDE solution. The second set of PVDF membrane samples were immersed in a DEA solution. The water flow performance as a function of the CO₂ plasma treatment time was measured and is shown in FIG. 8. The chart shows the plasma and chemically treated membrane samples both before and after autoclave. Again, the autoclave was conducted under the conditions described above. As can be seen from the figure, particularly after autoclaving, the chemical solution treatment after CO₂ plasma treatment showed significant improvement in water flow rate for the membranes. Again, the percent weight changes of the PVDF membranes after autoclave are also shown on the chart. Very little weight change occurs from the autoclave after the membranes have been immersed in the respective chemical solutions. Moreover, FIG. 9 illustrates the low extractable nature of the hydrophilic surface created by the CO₂ plasma treatment. The bar graph shows that immersion of the treated membranes in either the EGDE or DEA solutions has no appreciable effect on the low extractable nature of the CO₂ plasma treated membranes. The post-plasma chemical treatment, therefore, is effective to further increase the wettability of the PVDF membranes, without increasing the amount of extractables that could be eluted from the membrane.

In exemplary embodiment, a filtration device can employ the hydrophilic porous membrane described herein. The filtration device can be in any form such as, for example, a cartridge, a plate-frame assembly, a disc, and the like. The filtration device can comprise a housing and the hydrophilic porous polymer membrane of any of the above described embodiments. The membrane can be in any suitable form and can be utilized as an integral part of a filter element.

In another exemplary embodiment, a method of treating a fluid by contacting a fluid with the hydrophilic polymer membrane can comprise contacting a fluid (e.g., an aqueous fluid) with the an embodiment of the membrane described herein, passing the fluid through the membrane to provide a filtrate (e.g., removing a substance from the fluid), and recovering the filtrate and/or the retentate.

Further, the CO₂ plasma treated hydrophilic membranes as described above can be employed in numerous other applications, including but not limited to, water purification, chemical separations, charged ultrafiltration membranes, protein sequestration/purification, waste treatment membranes, biomedical applications, pervaporation, gas separation, the fuel cell industry, electrolysis, dialysis, cation-exchange resins, batteries, reverse osmosis, dielectrics/capacitors, industrial electrochemistry, SO₂ electrolysis, chloralkali production, and super acid catalysis. As described herein, the hydrophilic polymer membranes can be produced without the need to introduce a secondary hydrophilic polymer to the system. The membranes, therefore, can be single layered, or have multiple layers. Moreover, when the hydrophilic polymer membranes are immersed in a chemical solution after plasma treatment, the hydrophilicity of the membrane can be increased. Even further, the water flow rates of the membranes can be further increased after autoclave of the plasma treated hydrophilic polymer membrane. The membranes can be capable of wetting out completely, and can demonstrate high fluxes of water and little to no extractables after autoclave cycles.

The terminology used herein is for the purpose of describing particular embodiments only and is not intended to be limiting of the invention. Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Unless otherwise defined, all terms (including technical and scientific terms) used herein have the same meaning as commonly understood by one of ordinary skill in the art to which the embodiments of the invention belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A process of forming an integral hydrophilic membrane from a porous hydrophobic membrane, the process comprising:
exposing a porous hydrophobic polymer membrane to a plasma, wherein the plasma comprises reactive carbon dioxide species configured to covalently bond functional groups to a surface of the polymer membrane and form the integral hydrophilic membrane.

2. The process of claim 1, wherein the hydrophobic polymer is a fluorinated polymer, wherein the fluorinated polymer comprises polytetrafluoroethylene, expanded polytetrafluoroethylene, polyvinylidene fluoride, polyvinylidene difluoride, poly(tetrafluoroethylene-co-hexafluoropropylene, poly(ethylene-alt-tetrafluoroethylene), polychlorotrifluoroethylene, poly(tetra-fluoroethylene-co-perfluoropropyl vinyl ether), poly(vinylidene fluoride-co-hexafluoropropylene, polyvinyl fluoride, or a combination comprising at least one of the foregoing.

3. The process of claim 2, wherein the functional group comprises carboxylic acid, carboxylate, latent carboxylic acid, or a combination comprising at least one of the foregoing functional groups bonded pendant to the fluorinated polymer.

4. The process of claim 1, wherein the plasma comprises about 1 percent to about 100 percent by weight of carbon dioxide.

5. The process of claim 1, wherein the porous hydrophobic polymer membrane is exposed to the reactive carbon dioxide species for a duration of about 10 seconds to about 120 minutes.

6. The process of claim 1, wherein a flow rate of the plasma across the surface of the porous hydrophobic polymer membrane is about 0.1 slm to about 100 slm.

7. The process of claim 1, wherein the exposing comprises placing the porous hydrophobic polymer membrane between electrodes configured to generate the reactive carbon dioxide species.

8. The process of claim 1, further comprising immersing the integral hydrophilic membrane in a chemical solution that increases hydrophilicity of the membrane.

9. The process of claim 8, wherein the chemical solution comprises a reagent configured to covalently or ionically bond to the membrane.

10. The process of claim 9, wherein the reagent comprises alcohol, thiol, alkene, epoxide, amine, or a combination comprising at least one of the foregoing.

11. The process of claim 8, wherein the chemical solution comprises a reactive species in a basic solution, wherein the reactive species comprises ethylene oxide, propylene oxide, glycidyl trimethylammonium chloride, glycidol or a combination comprising at least one of the foregoing reactive species, and the basic solution comprises triethylamine, 4-dimethylaminopyridine, sodium hydroxide, or the like base, or a combination comprising at least one of the foregoing basic solutions.

12. The process of claim 1, further comprising autoclaving the integral hydrophilic membrane to further increase a water flow rate through the membrane.

13. The process of claim 1, further comprising immersing the integral hydrophilic membrane in the chemical solution; removing the integral hydrophilic membrane from the chemical solution; and autoclaving the removed membrane.

14. A membrane formed by the process of claim 1.

15. A filtration device comprising a housing, and the membrane of claim 14.

16. An integral hydrophilic membrane, comprising:
a porous fluorinated polymer membrane comprising a surface; and
a functional group covalently bonded pendant to the fluorinated polymer surface, wherein the functional group are configured to provide hydrophilicity to the surface, and wherein the functional group consists of carboxylic acid, carboxylate, latent carboxylic acid, or a combination comprising at least one of the foregoing.

17. The integral hydrophilic membrane of claim 16, wherein the fluorinated polymer is polyvinylidene difluoride.

18. The integral hydrophilic membrane of claim 17, wherein the hydrophilic membrane has the formula: 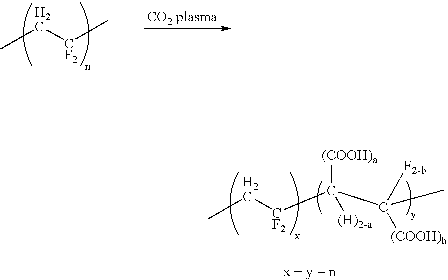
wherein a and b are integers from 0 to 2.

19. The integral hydrophilic membrane of claim 16, wherein the integral hydrophilic membrane has a flow rate of water greater than about 1 mL/min-cm² at 20 inches Hg pressure differential.

20. The integral hydrophilic membrane of claim 16, wherein the membrane is disposed in a filtration device.
